(19) United States
(12) Patent Application Publication
(10) Pub. No.: US 2021/0291387 A1
(43) Pub. Date: Sep. 23, 2021

(54) KNIFE WITH SOUND EMITTING MEANS USING THE FLOW OF AIR

(71) Applicant: Opinel, Chambery (FR)

(72) Inventor: Denis PORRET, Chambery (FR)

(73) Assignee: Opinel, Chambery (FR)

(21) Appl. No.: 17/246,851

(22) Filed: May 3, 2021

Related U.S. Application Data
(63) Continuation of application No. 15/012,136, filed on Feb. 1, 2016.
Application No. 15/012,136 is a continuation of application No. 13/557,350, filed on Jul. 25, 2012, now abandoned.

(30) Foreign Application Priority Data
Jul. 29, 2011 (FR) 1156940

(51) Int. Cl. B26B 11/00; G10K 5/00

(52) U.S. Cl. CPC B26B 11/00; G10K 5/00

(57) ABSTRACT

A knife with a handle and a blade, associated with means adapted to emit sound using an air flow, the said means being incorporated inside the body of the said handle, and being of the whistle type, and comprising a recess connected to a mouthpiece located upstream, through which the said flow of air is introduced, and connected to an exit window located downstream. An air compression chamber located downstream from the mouthpiece, opens through a hole into an expansion chamber (or pressure relief chamber) which is itself connected to the said exit window. The compression chamber is such that its section along a plane orthogonal to the air flow reduces, preferably in a linear manner, in the direction of the expansion chamber. The exit window has a bevelled edge on the side opposite the compression chamber. The compression chamber opens onto two parallel expansion chambers having different lengths.

### BACKGROUND ON THE INVENTION

This invention relates to a knife with means to emit sound using the flow of air, of the whistle type, and particularly a knife with a folding blade.

In some situations, it may be useful, or necessary, or even of vital importance to be able to signal one's presence or attract the attention of others. That may be so of people in trouble, during outdoor sports or leisure activities in a wild or uninhabited environment, such as hiking, mountain climbing, pleasure boating or others.

Whistles have been known for a very long time, with balls or using other techniques, that use the flow of air to emit a sound, which is generally high pitched.

Such whistles have the drawback of being one more piece of safety equipment to be carried by their users, along with a magnifying glass, knife, lamp, compass etc.

In a known manner, it has been proposed to add a whistle to another tool, particularly a knife, in a removable or permanent manner.

While that known system makes it possible to bring together two functions (knife and whistle) in the same object, it does not provide any additional convenience to the user in terms of weight or volume.

Further, using a whistle added to the handle of a knife that stands out from the handle can be inconvenient. Conversely, the presence of a whistle standing out from the handle of the knife can hinder the user of the knife.

If the whistle is added in a removable manner on the handle of a knife, it has the drawback mentioned before.

### SUMMARY OF THE INVENTION

The invention aims to remedy those drawbacks and proposes a knife with means to emit sound using the flow of air, of the whistle type, wherein the presence of the means does not hinder the user of the knife in any way, and wherein firstly, the whistle can be used easily and comfortably, and secondly, no weight is added to the knife.

Lastly, the invention also applies to knives with folding blades, and the whistle does not affect the folding of the blade in the handle.

To that end, according to the invention, there is provided a knife with a handle and a blade, associated with means of the whistle type adapted to emit sound using an air flow, the said means comprising a recess connected to a mouthpiece located upstream, through which the said flow of air is introduced, and connected to an exit window located downstream, and an air compression chamber located downstream from the mouthpiece, opening (through a hole) into an expansion chamber (or pressure relief chamber) which is itself connected to the said exit window, characterised in that the said whistle means are integrated into the body of the handle, incorporated inside the body of the said handle, and in that the handle is made by moulding and that the compression chamber, pressure relief chambers and exit windows are made while moulding using reservations or the like to make the required recesses.

Advantageously, the handle is made of a single piece.

The compression chamber is such that its section along a plane orthogonal to the longitudinal axis of the handle (or orthogonal to the air flow) reduces, preferably in a linear manner, in the direction of the expansion chamber.

More particularly, on one of the internal sides of the compression chamber, a block with a rectangular base and a trapezoidal section is fixed so as to create a rising ramp from the mouthpiece to the hole communicating firstly with the expansion chamber (pressure relief chamber) and secondly with the exit window.

The exit window has a bevelled edge on the side opposite the compression chamber.

The compression chamber opens onto two distinct expansion chambers that are sealed from each other and each open onto an exit window.

The two expansion chambers are elongated in shape, parallel, and have different lengths in the air flow direction (parallel to the longitudinal axis of the handle).

The sound emitting means are arranged in the handle so that the direction of the air flow is parallel, preferably co-linear, to the longitudinal axis of the handle.

The blade can be folded into a slot provided in the handle that separates the handle into two contiguous parts that oppose each other along a longitudinal and substantially median plane of the handle, the said sound emitting means being then incorporated into one of the said parts.

On a plane transversal to the longitudinal axis of the knife, the compression chamber is rectangular in section, whilst the expansion chamber has a square section.

The means have the following dimensions for a handle with a 20-mm diameter:
the section of the mouthpiece is between 40 and 46 mm²;
the length of the first expansion chamber is approximately 30 mm;
the length of the second expansion chamber is approximately 36 mm;
the volume of the compression chamber is approximately 420 mm³;
the upstream section of the compression chamber is approximately 45 mm² ;
the downstream section of the compression chamber is approximately 12 mm².

The handle is made of plastic, preferably thermoplastic and may contain reinforcing fibres, for example polyamide (PA), in particular with fibreglass reinforcement, or polybutylene terephthalate (PBT).

The handle, which is substantially cylindrical in shape, is moulded in a single piece using a slide mould so as to reserve the parts that are designed to become chambers, hollows and conduits.

In the case of knives with folding blades, a central hollow is provided in the handle to accommodate the blade (at least most of the blade).

The compression chamber, the compression or pressure relief chamber or chambers and the window or windows are made, while moulding, by reservation is or other known means to make the necessary recesses.

### DESCRIPTION OF THE DRAWINGS

The invention will be better understood in the light of the description below relating to illustrative but non-limitative examples of the invention, by reference to the accompanying drawings, wherein:

FIG. 1 is an exploded perspective view of the knife with a folding blade of the invention;

FIG. 2 is a top view of the knife, the blade being folded in the handle.

FIG. 3 is a side view of the knife with the blade unfolded.

FIG. 4 is a rear view of the handle of the knife showing the mouthpiece of the whistle.

FIG. 5 is a simplified schematic view showing, in a longitudinal section along a horizontal plane, the principle of the whistle incorporated in the handle of the knife.

FIG. 6 is a simplified top view, in a longitudinal section on a vertical plane, of an alternative whistle of FIG. 5.

FIG. 7 is a schematic side view of the handle alone.

FIG. 8 is a sectional view along a plane H-H of FIG. 7.

FIGS. 9A, 9B, 9C, 9D and 9E are cross-sectional views along vertical planes corresponding with different sections of the handle of FIG. 7, including the whistle shown in FIGS. 6 and 8.

### DETAILED DESCRIPTION OF THE INVENTION

The terms ‘horizontal’, ‘vertical’, ‘top’ and ‘side’ refer to the natural positions when the knife is normally in use in the user's hand, as for example in the side view of FIG. 3. A so-called ‘vertical’ plane is thus parallel to the plane in the figure and a so-called ‘horizontal’ plane is perpendicular to the plane in FIG. 3.

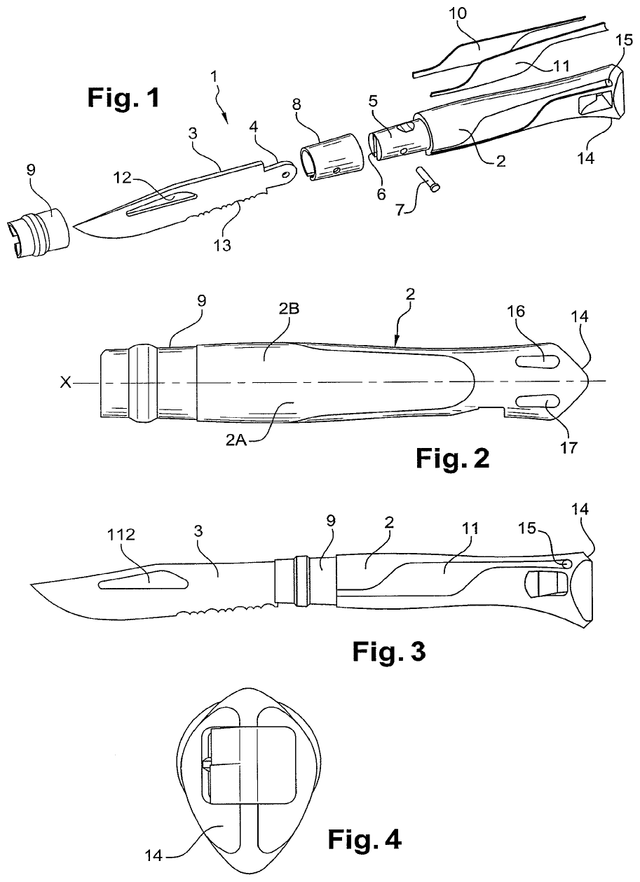

By reference to FIG. 1, the knife of the invention is described by reference to a so-called pocket knife, with a folding blade, shown in an exploded perspective view.

The knife 1 comprises an elongated handle 2, a blade 3 with a proximal end comprising a heel 4 (close to the handle) mounted articulated on the handle 2 at its proximal end 5 that comprises a recess 6 capable of accommodating the heel 4.

A split ring 8 covers the end 5 of the handle 3, with the split matching and in line with the recess 6.

The articulation of the blade 3 on the handle is provided by a pin 7 that goes through the ring 8, the end 5 of the handle 2 and the heel 4 of the blade 3.

The blade 3 can be folded into the handle, which comprises a corresponding recess (not visible in the figure).

A split ferrule 9 covers the ring 8 and can rotate in relation to the ring. Means known in themselves and not illustrated are provided to prevent any longitudinal displacement of the ferrule 9.

The ferrule 9, depending on its position while rotating, makes it possible to allow the blade 3 to pass (when the splits of the ferrule 9 and the ring 8 are lined up) or lock the blade (the ferrule 9 preventing the passage of the blade) either in the open unfolded position (FIG. 3) or the closed position, with the blade folded away into the handle (FIG. 2 top view).

By reference to FIG. 1 once again, the knife may optionally have the following additional characteristics:
Side pieces 10 and 11 are provided on either side of the handle, for decorative or functional purposes (in material that makes it easier to grasp); these side pieces are made of plastic so as to allow them to be fixed onto the handle by means of polymerisation,
The blade 3 comprises a hole 12 shaped like a shackle opener and at least a part 13 of its active edge is notched.
The distal end 14 (opposite the blade) of the handle 3 has a through hole 15 through which a ring can be passed (not shown). The hole 15 is associated with two side flat sections 18 and 17 (FIG. 2).

Further, the knife 1 of the invention comprises sound emitting means of the whistle type incorporated in the handle and described below by reference to FIGS. 5 to 7.

FIG. 5 is a simplified schematic view showing the operating principle of the whistle in a longitudinal section of a tube-shaped block with a rectangular section that symbolises the handle of the knife. The section is along a horizontal plane when the knife is as shown in FIG. 3.

The whistle is represented schematically in the form of a tube 18 with at one end a mouthpiece or mouth 19 and with another end 20 which is closed. The mouth 19 is made on an open side of a compression chamber 21, itself connected at its other end (opposite the mouth 19) by a hole 22 to an expansion or pressure relief chamber 23 (with a parallelepiped shape).

The upper wall of the latter has an exit window 24 located near the said hole 22. The downstream edge of the window 23 opposite the compression chamber 21 has a bevel 25.

The compression chamber 21 has a prismatic shape with a trapezoidal transverse section. A block 26 with a square or rectangular section and trapezoidal section is provided in the downstream part of the tube 18. The oblique wall 26A of the block 26, with an ascending slope up to the hole 22, demarcates the compression chamber 21 with the other walls of the tube 18. In other words, the straight section in a vertical plane of the mouth 19 is larger than that of the hole 22 communicating with the pressure relief chamber 23. The slope of the oblique wall 26A is between 5° and 20°, preferably 10° to 13°, with a length (in the longitudinal direction of the handle) of approximately 18 mm.

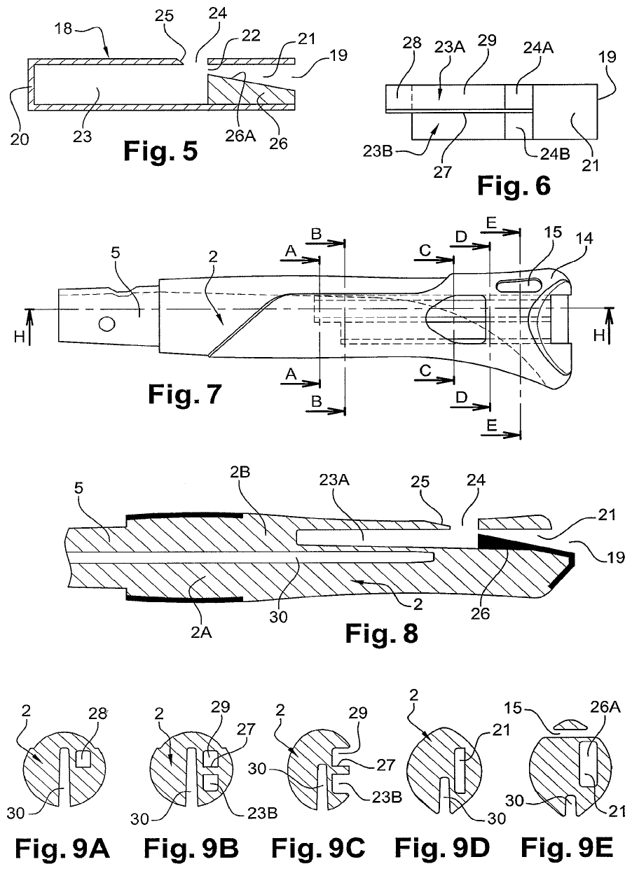

FIG. 6 is a schematic view of a longitudinal section along a horizontal plane of a preferred embodiment of the whistle incorporated in the handle, the said section being made in the position of the knife shown in FIG. 3.

That alternative whistle differs from that in FIG. 5 in that it comprises two pressure relief chambers 23A and 23B that are parallel and separated by a common wall 27, each opening out on an exit window 24A and 24B. The two pressure relief chambers 23A and 23B are placed on the same level along the vertical plane, side by side.

The first pressure relief chamber 23A is longer than the second one 23B and comprises a first part 28 (near the blade of the knife) that goes beyond, in the longitudinal direction, a second part 29 that opens onto the window 24A. The second part 29 has the same length as the second pressure relief chamber 23B. The single compression chamber 21 placed upstream opens Into the two pressure relief chambers 23A and 23B.

The pressure relief chambers 23A and 23B have different lengths and emit sounds with different frequencies through their respective exit windows 24A and 24B.

As shown in FIG. 6 the exit windows 24A and 24B have a bevelled downstream edge (near the blade) to improve the sound.

On the plane of FIG. 6, the pressure relief chambers 23A and 23B are 30 mm and 25 mm long respectively, and 5 mm wide. The thickness of the dividing partition 27 is approximately 1.1 mm.

FIG. 7 is a schematic side view of the knife according to the invention, in the handle of which is integrated a whistle like the one shown in a sectional view in FIG. 6 and also shown in FIG. 8 in a section along a horizontal plane H-H (see FIG. 7).

FIG. 8 is a sectional view similar to that in FIG. 5, because both of them are made on horizontal planes, whilst FIG. 6 is a sectional view along a vertical plane.

The dimensions of the exit windows 24A and 24B are identical, namely, in a top view (FIG. 6): 5 mm×5.5 mm.

FIGS. 9A to 9E are transverse sectional views of the handle at different locations of the handle, along successive vertical, transverse planes with references M, BB, CC, DD and EE. Plane AA is closest to the blade.

The handle has a longitudinal recess 30 on a vertical plane, with a quadrangular section, designed to accommodate the blade (not shown).

FIG. 9A is a sectional view along the plane AA, showing the first part 28 of the first pressure relief chamber 23A with a square section (4.8 mm×4.3 mm).

FIG. 9B is a sectional view along the plane BB, showing the second part 29 of the first pressure relief chamber 23A and the second pressure relief chamber 23B with a square section (5.3 mm×4.3 mm).

FIG. 9C is a sectional view along the plane CC, showing the second part 29 of the first pressure relief chamber 23A and the second pressure relief chamber 23B with a square section (5.3 mm×4.3 mm). The sectional view is located at the neighbouring exit windows 24A and 24B and shows the partition 27 that divides the two pressure relief chambers 23A and 23B.

FIG. 9D is a sectional view along plane DD showing the compression chamber 21 with a rectangular section (2 mm×11.5 mm) at the back of the said chamber (opposite the end 14 of the handle).

The FIG. 9E is a sectional view along plane EE showing the compression chamber 21 with a rectangular section (3.5 mm×11.5 mm) and the through opening 15 in a direction transversal to the longitudinal axis of the handle.

The handle 2 of the knife is made of thermoformable plastic, such as polyamide (PA) or PST (polybutylene terephthalate).

The handle is moulded in a single piece and comprises two parts, the so-called left park 2A and the so-called right part 2B (by reference to FIG. 8). The thickness of the central hollow 30 (for the blade) is approximately 2.2 mm.

The right-hand part 2B of the handle includes the whistle of the invention. The compression chamber, the pressure relief chambers and the exit windows are made, while moulding, by reservation or other known means to make the necessary recesses.

The whistle described above is integrated to the body of the handle and is made inside the handle.

By blowing into the mouthpiece 19, the user creates an air flow that enters into the compression chamber 21. Because of the ramp 26, the air flow pressure increases at the exit of the chamber 21 and then enters, after passing through the hole 22, into the pressure relief chamber 23, or the two pressure relief chambers 23A and 23B from where the air then escapes from the window 24 or the two windows 24A and 24B. The fact that the pressure relief windows have different lengths makes it possible to emit sounds through each window with different frequency spectra, where one is higher than the other. The end result only increases the overall power of the emitted sound, which in this case can be heard several hundreds of metres away.

1-8. (canceled)

9. A knife with a handle and a blade, associated with a whistle adapted to emit sound using an air flow, the whistle comprising an opening connected to a mouthpiece located upstream, through which airflow is introduced, and connected to an exit window located downstream relative to the mouthpiece, and an air compression chamber, located downstream from the mouthpiece, said air compression chamber opening through a hole into an expansion chamber, which expansion chamber has a larger cross section than the air compression chamber, and the expansion chamber is connected to the exit window, wherein the whistle is integrated into the body and incorporated completely inside the handle, the blade is secured to the handle and adapted to be folded into a longitudinal slot provided in the handle that separates the handle into two contiguous parts that oppose each other along a longitudinal and substantially median plane of the handle, the whistle being then incorporated into one of the contiguous parts, wherein the whistle and the two contiguous parts of the handle are moulded together so that both the whistle and the two contiguous parts of the handle form a single piece of plastic, and wherein the compression chamber is a single compression chamber which opens into two distinct expansion chambers that are sealed from each other and that each open onto an exit window.

10. The knife according to claim 9, wherein the air compression chamber is such that the air compression chamber's section along a plane orthogonal to the longitudinal axis of the handle reduces in the direction of the expansion chamber.

11. The knife according to one of claim 9, wherein the exit window has a bevelled edge on the side opposite the air compression chamber.

12. The knife according to claim 9, wherein the whistle is arranged in the handle so that the direction of the air flow is parallel to the longitudinal axis of the handle.

13. The knife according to claim 9, wherein the blade comprises a hole shaped like a shackle opener and at least part of its cutting edge is nothched.

14. The knife according to claim 9, wherein the plastic is thermoplastic plastic.

15. The knife according to claim 14, wherein the thermoplastic plastic is polyamide (PA) or polybutylene terephthalate (PBT).

16. The knife according to claim 9, wherein the air compression chamber includes a block having an oblique wall whose slope up to the hole is between 5° and 20°.

17. The knife according to claim 9, wherein a distal end of the handle has a through hole through which a ring can be passed, said through hole being separated from the whistle by two side flat sections.
